(19) United States
(12) Patent Application Publication
(10) Pub. No.: US 2009/0270779 A1
(43) Pub. Date: Oct. 29, 2009

(54) Face Massage Roller

(75) Inventor: Fumio Kurosu, Kanagawa-ken (JP)

Correspondence Address: Konomi Takeshita, Eight Penn Center, Suite 1300,, 1628 John F. Kennedy Blvd., Philadelphia, PA, 19103, US

(73) Assignee: Homare Co., Ltd., Chiba-ken (JP)

(21) Appl. No.: 12/426,631

(22) Filed: Apr. 20, 2009

(30) Foreign Application Priority Data
Apr. 28, 2008 (JP) 2008-002754

(51) Int. Cl. A61H 15/00

(52) U.S. Cl. 601/119

(57) ABSTRACT

The purpose of the present device is to provide a face massage roller, which achieves more excellent massaging effect than conventional roller type face massage rollers. A face massage roller is provided having cylindrical 1^{st}, 2^{nd}, 3^{rd}, 4^{th} and 5^{th} rollers, which are supported by shafts in a rotatable state in a frame part of a head part installed at a tip of a handle part, wherein the 1^{st}, 3^{rd} and 5^{th} rollers are mutually parallel and fall at right angles with the direction of the longitudinal axis of the handle part, and the rotary central axes of the 2^{nd} and 4^{th} rollers form a predetermined angle of inclination with the direction of the rotary central axis of the 3^{rd} roller, so that the 2^{nd} and 4^{th} rollers, which are on either side of the 3^{rd} roller, assume an approximately Japanese character “ [symbol] ” form.

### CROSS REFERENCE TO RELATED APPLICATIONS

This application claims priority under 35 U.S.C. 119 based upon Japanese Utility Model Application No. 2008-002754, filed on Apr. 28, 2008. The entire disclosure of the aforesaid application is incorporated herein by reference.

### BACKGROUND OF THE INVENTION

1. Field of the Invention

The present device relates to a massage roller for performing a massage on a face by holding it by hand.

2. Description of the Related Art

A massage roller for, easily and at anytime users want, performing a massage on a face by holding it by hand is known in the art. Such a massage roller has a long rod shaped handle and a plurality of rollers or balls, which are installed in a rotatable way at one end of the handle, and the rollers or the balls are moved back and forth, while being held to the face.

The massaging effect, such as the improvement of the blood circulation and the canceling of swelling, is achieved by the above-mentioned massaging device, by promoting hypodermic blood stream and lymph flow, while giving moderate stimulation to the skin, through some friction and pressing on the face caused by the plurality of rollers or balls (e.g., refer to Japanese Utility Model Registration No. 3087105 and Japanese Unexamined Utility Model Publication No. 06-061235).

In the above-mentioned conventional massaging device, all of the rollers and balls rotate in the same direction. Thus, the main massaging effect is the promotion of the blood stream and lymph flow.

However, many users expect that a face massaging device achieves a further cosmetic effect, in addition to the massaging effect of canceling swelling by improving blood circulation.

Thus, a face massage roller which achieves a more excellent massaging effect than the conventional roller type face massaging device is highly desired.

### SUMMARY OF THE INVENTION

To solve the above mentioned problem, according to the present invention there is provided a face massage roller having a long rod shaped handle part and a head part for massaging, which is installed at the tip of the handle part, wherein a) the head part has a frame part, and 1^{st}, 2^{nd}, 3^{rd}, 4^{th} and 5^{th} rollers, the frame part being formed with the handle part in one piece, and the rollers being cylindrical, being supported by shafts in a rotatable state in the frame part, and having a surface subjected to anti skid processing, b) the 1^{st} to 5^{th} rollers are arranged side by side in the direction of the longitudinal axis of the handle part, in turn from the outside of the handle part, and the rotary central axes of the 1^{st}, 3^{rd} and 5^{th} rollers, among the five rollers, are mutually parallel and fall at right angles with the direction of the longitudinal axis of the handle part, and c) the rotary central axes of the 2^{nd} and 4^{th} rollers form the predetermined angle of inclination with the direction of the rotary central axis of the 3^{rd} roller, so that the 2^{nd} and 4^{th} rollers, which are on either side of the 3^{rd} roller, assume an approximately Japanese character [symbol] form.

In another aspect of the invention, in relation to the direction of the rotary central axis of the 3^{rd} roller, the angles of inclination of the rotary central axes of the 2^{nd} and 4^{th} rollers are within the range of 0.2° and 2°, and are independent from each other.

According to a further aspect of the invention, the lengths of the 2^{nd} and 4^{th} rollers in the direction of their rotary central axes are bigger than the length of the 1^{st} and 5^{th} rollers in the direction of their rotary central axes, a nd the length of the 3^{rd} roller in the direction of its rotary central axis is bigger than the length of the 2^{nd} and 4^{th} rollers in the direction of their rotary central axes.

In yet another aspect of the invention, the lengths of the 2^{nd} and 4^{th} rollers in the direction of their rotary central axes are bigger than the length of the 1^{st} and 5^{th} rollers in the direction of their rotary central axes, and the length of the 3^{rd} rollers in the direction of its rotary central axis is bigger than the length of the 2^{nd} and 4^{th} rollers in the direction of their rotary central axes.

In still another mode of the invention, the outer diameters of the 2^{nd} and 4^{th} rollers are smaller than the outer diameters of the 3^{rd} rollers, and the outer diameters of the 1^{st} and 5^{th} rollers are smaller than the outer diameters of the 2^{nd} and 4^{th} rollers.

In yet a further mode of the invention, each of the 1^{st} to 5^{th} rollers is held by bearing parts through a pair of plastic shaft members, the bearing parts being formed in the frame part, and the plastic shaft members being fitted with the cylindrical inner periphery at both ends of the rollers, in a way that the plastic shaft members cover the end surfaces of the corresponding roller.

According to still another mode of the invention, a) the face massage roller has a back lid, which is installed in the frame part, so that the rear surface of the head part is covered by the back lid, and b) a magnet(s) and an infrared rays radiation ceramic part(s) are installed between the inner side of the back lid and the 1^{st} to 5^{th} rollers.

In the face massage roller, according to the present device, among the 1^{st}, 2^{nd}, 3^{rd}, 4^{th} and 5^{th} rollers, which are supported by shafts in a rotatable state in the frame part of the massaging head part at the tip of the long rod shaped handle part, the rotary central axes of the 2^{nd} and 4^{th} rollers form the predetermined angle of inclination with the direction of the rotary central axis of the 3^{rd} roller, so that the 2^{nd} and 4^{th} rollers, which are on either side of the 3^{rd} roller, assume an approximately Japanese character [symbol] form. The 2^{nd} and 4^{th} rollers are on either side of the 3^{rd} roller, and, like the 1^{st} and 5^{th} rollers, are arranged to be mutually parallel and fall at right angles with the direction of the longitudinal axis of the handle part. Therefore, the 2^{nd} roller and the 4^{th} roller rotate in a mutually different direction, and the skin parts, with which the 2^{nd} and 4^{th} rollers come in contact, are pulled in a different direction respectively. As a result, the skin between the 2^{nd} and 4^{th} rollers is massaged with the 3^{rd} roller in an extended state, and the effect of wrinkle extending, in addition to the improvement of the blood circulation and the canceling of swelling, can be achieved at the same time.

### BRIEF DESCRIPTION OF THE DRAWINGS

FIG. 1 is a summarized schematic view, showing the face massage roller according to a 1st embodiment of the present device. (a) is a plane view, (b) is a side view and (c) is a sectional view taken along the plane A-A of (a).

FIG. 2 is a schematic view, showing the structure of a shaft member, which is fitted with the cylindrical inner periphery of each roller. (a) is a side view, showing the state before the insertion of the shaft members, (b) is a sectional view, showing the early state of the insertion of the shaft members and (c) is a side view, showing the state, in which the insertion of the shaft members is completed.

FIG. 3 is a side sectional view, showing a summarized constitution of the face massage roller according to the 2nd embodiment of the present device.

### DETAILED DESCRIPTION OF THE PREFERRED EMBODIMENTS

In the face massage roller, according to the present device, among the 1^{st}, 2^{nd}, 3^{rd}, 4^{th} and 5^{th} rollers, which are supported by shafts in a rotatable state in the frame part of the massaging head part at the tip of the long rod shaped handle part, the rotary central axes of the 2^{nd} and 4^{th} rollers form the predetermined angle of inclination with the direction of the rotary central axis of the 3^{rd} roller, so that the 2^{nd} and 4^{th} rollers, which are on either side of the 3^{rd} roller, assume an approximately Japanese character [symbol] form. The 2^{nd} and 4^{th} rollers are on either side of the 3^{rd} roller, and, like the 1^{st} and 5^{th} rollers, are arranged to be mutually parallel and fall at right angles with the direction of the longitudinal axis of the handle part. As a result, when the movement operation is done, holding the head to a face, each roller rotates in its rotary direction, and the 2^{nd} roller and the 4^{th} roller rotate in a mutually different direction. Thus, the skin parts, with which the 2^{nd} and 4^{th} rollers come in contact, are pulled in a different direction respectively, and the skin between the 2^{nd} and 4^{th} rollers is massaged with the 3^{rd} roller in an extended state.

When face massaging is performed by the face massage roller according to the present device, the effect of wrinkle extending, in addition to the improvement of the blood circulation and the canceling of swelling, can be achieved at the same time, by the same simple operation of moving the head part back and forth, pressing it against a face, as with conventional massaging devices.

The angles of inclination of the rotary central axes of the 2^{nd} and 4^{th} rollers in relation to the rotary central axis of the 3^{rd} roller is preferably within the range of 0.2° and 2°. That is, it is suitable for the above-mentioned massaging effect of extending wrinkles that the angle between the rotary central axes of the 2^{nd} roller and the 4^{th} roller, which together form an approximately Japanese character [symbol] , is at the smallest 0.4° and at the largest 2°. In the case where the angle is smaller than the above-mentioned range, a sufficient effect of extending wrinkles cannot be achieved, and the feeling of use is also the same as with an ordinary massaging device, in which all the rollers are arranged parallel to each other. In the case where the angle is larger than the above-mentioned range, the direction of pulling by the 2^{nd} roller and the 4^{th} roller is so far to each other that a strong pulling, causing pain on the skin, is produced.

As a method of arranging the 2^{nd} and 4^{th} rollers in relation to the other rollers with a certain angle, for example, it is preferable to employ the constitution in which the bearings in the side of the frame part are formed in a way that their directions have the predetermined angles. In this case, designing and manufacturing are simple, because the constitution of the rollers themselves is the same as that of the other rollers.

The lengths of the 1^{st} to 5^{th} rollers in the direction of their rotary central axes may be the same. However, in the case where the following constitution is employed, that is, the lengths of the 2^{nd} and 4^{th} rollers in the direction of their rotary central axes are larger than the length of the 1^{st} and 5^{th} rollers in the direction of their rotary central axes, and the length of the 3^{rd} rollers in the direction of its rotary central axis is larger than the length of the 2^{nd} and 4^{th} rollers in the direction of their rotary central axes, in other words, by making the length of the 3^{rd} roller, located in the middle, in the direction of its rotary central axis the longest, and making the lengths of the 2^{nd} and 4^{th} rollers, located on either side of the 3^{rd} roller, in the direction of their rotary central axes the second longest, and making the lengths of the 1^{st} and 5^{th} rollers, located at either end, in the direction of their rotary central axes the shortest, the effect achieved is a widening of the skin which contacts the central part, (namely the 3^{rd} roller and the 2^{nd} and 4^{th} rollers) which has the most excellent massaging effect among the surface area of the skin contacting side of the head part.

It is more preferred that the surface of the head part, which comes in contact with the face as an uneven curved surface, is rather a curved surface, which protrudes in the upper direction, rather than a plain surface. By employing the above-mentioned constitution, all the rollers rotate in an ideal state for massaging, because it becomes easy for all the rollers to press the face surface more uniformly. To employ this constitution, the 1^{st} and 5^{th} rollers may be arranged in a way that the curved line, assumed by connecting the top of each roller on the surface side of the head part, along the direction of the longitudinal axis of the handle part, forms an approximately arc shape, which protrudes in the upper direction of the frame part.

So as to employ the constitution in which the curved line (assumed by connecting the top of each roller) forms an approximately arc shape, in the case in which the outer diameters of the 1^{st} to 5^{th} rollers are all the same, the end parts of both right and left sides of the frame part (which support the rollers by shafts) are curved into the shape of an arc, in such a way that the surface side protrudes in the upper direction, and the bearings of each roller are installed along that curve. By doing this, the top of each roller lines up on the arc of the circle, which has a common center with that curve, and the surface of the head part, which is composed of the tops of all the rollers becomes substantially a curved surface, which curves toward the upper direction.

In the case in which the outer diameters of the 2^{nd} and 4^{th} rollers are smaller than the outer diameter of the 3^{rd} roller, and the outer diameters of the 1^{st} and 5^{th} rollers are smaller than the outer diameters of the 2^{nd} and 4^{th} rollers, the height from the central axis to the top of the 3^{rd} roller, which corresponds to its radius, is the largest, because the outer diameter of the 3^{rd} roller, located in the middle, is the largest. The height from the central axis to the top of the 2^{nd} and 4^{th} rollers, which are located on either side of the 3^{rd} roller and whose outer diameters are the second largest, is the second largest. Moreover, the height from the central axis to the top of the 1^{st} and 5^{th} rollers, which are located on either end side, and whose outer diameters are the smallest, is the smallest. Thus, the height from the central axis to the top of the rollers becomes gradually smaller from the center to both ends, when all the 1^{st} to 5^{th} rollers are supported by shafts, in such a way that their rotary central axes are on the same straight line. Therefore, the curved line, assumed by connecting the top of all the rollers, forms an approximately arc shape, and the surface of the head part becomes substantially a curved surface. Moreover, by adjusting the differences of the outer diameters of each roller, a desired amount of curvature for the arc, namely the desired curved surface can be obtained.

In this case, it is not necessary to curve the end parts of both right and left sides of the frame part, which support the rollers by shafts. Moreover, there is no difference in the positions of the bearings in the direction of height, because the above-mentioned end parts are not curved. Therefore, insertion of the shaft parts of the 2^{nd} and 4^{th} rollers, which are arranged with certain angels, into concave bearings is easy. As a result, designing and manufacturing of the frame part are simplified.

An easy way to support the 1^{st} to 5^{th} rollers by shafts in a rotatable state is that the bearing parts, formed in the frame part, support the shaft parts, installed on the rotary central axis on the end surface of the rollers. In this case, the shaft parts may be composed of a pair of plastic shaft members, which fit the inner diameter of the cylinder at both ends of each roller. Namely, the plastic shaft members are fitted with the cylindrical inner peripheries at both ends of the rollers. By employing this constitution, identical shafts can be used for the rollers of different length, as far as the inner diameters of the cylinders at both ends of the rollers are identical. This makes the product manufacturing process easy, because all the shafts have the identical shape.

In the case where the rollers and the frame are made of metal, such as stainless steel, the contact of the rollers with the frame part could cause an uncomfortable sound of metal collision during the rotation of the rollers. However, by employing the constitution in which the plastic shaft members cover the end surfaces of the corresponding roller, while the plastic shaft members are fitted with the cylindrical inner periphery at both ends of the rollers, generating the uncomfortable sound of metal collision can be prevented. This is because those shaft members function, at both ends of the rollers, as a buffer member between the frame part and the rollers.

Moreover, a magnet(s) and a ceramic part(s), which radiates far-infrared rays, may be installed in the face massage roller of the present device. A magnet generates magnetic waves, which further improve blood circulation, and far-infrared rays have a thermal effect. Thus, the massaging effect of the face massage roller can be improved. In this case, by installing the back lid in the frame part, in such a way that the rear surface of the head part is covered by the back lid, the magnet(s) and the infrared rays radiation ceramic part(s) can be installed and stored in the space formed between the inner side of the back lid and the 1^{st} to 5^{th} rollers.

For the anti skid processing subjected onto the surface of each roller, a processing is employed, which allows the rollers to rotate smoothly with appropriate friction, without giving the skin unnecessarily strong stimulation when used. For example, shallow and fine crisscross or net mesh knurling work is preferable. However, patterns are not limited to those mentioned above.

### Embodiment 1

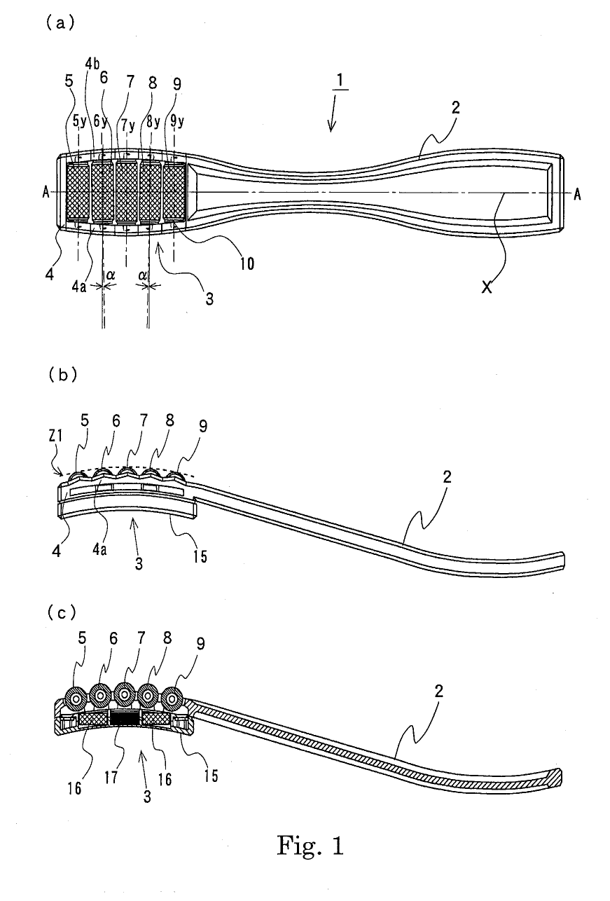

FIG. 1 is a schematic view, which shows the face massage roller of the first embodiment, according to the present device. FIG. 1, (a) is a plane view of this face massage roller, (b) is a side view of this face massage roller, and (c) is a sectional view along a plane A-A of (a). The present face massage roller 1 is mainly composed of a long rod shaped handle part 2 and a head part 3 for massaging, which is installed at the tip of the handle part. In the head part 3, 1^{st}, 2^{nd}, 3^{rd}, 4^{th} and 5^{th} rollers (5, 6, 7, 8, 9) are supported by shafts in a rotatable state, between the end parts (4a, 4b) of both right and left sides of the frame part 4, which is formed in one piece with the handle part 2. Those rollers are arranged in the direction of the longitudinal axis X of the handle part, in turn from the outside of the handle part 2.

The rotary central axes (5y, 7y, 9y) of the 1^{st}, 3^{rd} and 5^{th} rollers (5, 7, 9), among those five rollers, are mutually parallel and fall at right angles with the direction of the longitudinal axis X of the handle part 2. The 2^{nd} and 4^{th} rollers (6, 8) are supported in the frame part 4 by shafts, in such a way that their rotary central axes (6y, 8y) independently form angles from 0.2° to 2° of inclination a in relation to the direction of the rotary central axis 7y of the 3^{rd} roller 7. The 2^{nd} and 4^{th} rollers (6, 8) are arranged on either side of the 3^{rd} roller 7, and assume an approximately Japanese character [symbol] form.

In the present embodiment, the rollers are supported by shafts in a rotatable state, by loosely inserting the shaft parts, at both ends of the rollers, into concave bearings. Each of those concave bearings is formed at the corresponding location inside the end parts (4a, 4b) of both right and left sides (4a, 4b) of the frame part 4. Therefore, the 2^{nd} and 4^{th} rollers (6, 8) can be arranged with the predetermined angle α on either side of the 3^{rd} roller 8, in such a way that they form an approximately Japanese character [symbol] , by forming the concave bearings for the 2^{nd} and 4^{th} rollers (6, 8) with the predetermined angles.

All of the 1^{st} to 5^{th} rollers (5, 6, 7, 8, 9) have a cylindrical shape with the same outer diameter and the same inner diameter. The surfaces of the rollers are subjected to shallow and fine crisscross knurling work as an anti skid processing. All around, the outer peripheral parts of both end parts of each roller are subjected to a C shape chamfering.

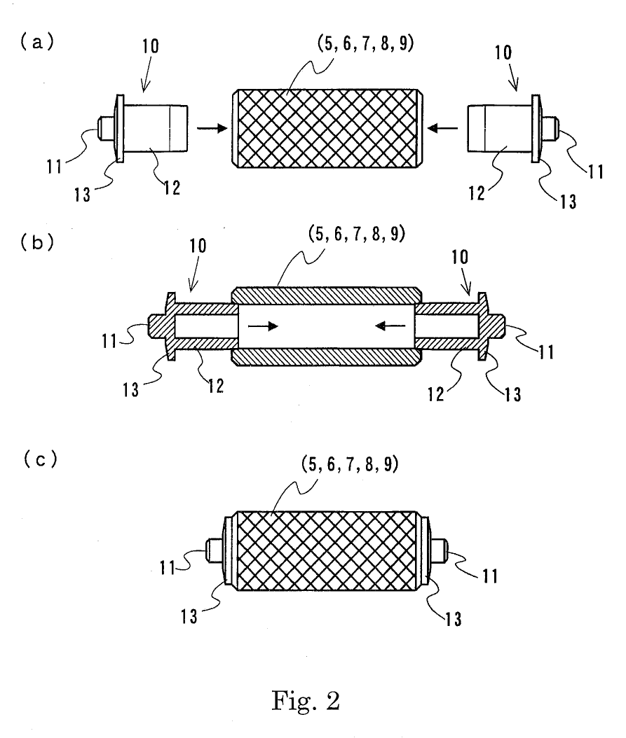

The shaft parts, for inserting each roller in the concave bearings formed in the end parts (4a, 4b) of both right and left sides of the frame part 4, are composed of a plastic shaft member 10, which is fitted with the cylindrical inner periphery at both ends of the rollers, as shown in FIG. 2(a). Those shaft members 10 are composed of a cylindrical fitting part 12, which is inserted inside the cylinder from both sides of the rollers and fitted with the cylindrical inner periphery, a shaft projection 11 and a flange part 13, which is between the cylindrical fitting part 12 and the shaft projection 11. Those three parts are formed in one piece.

The diameter of the tip part of the cylindrical fitting part 12 is a little smaller, so that the tip part can easily be inserted in the cylinder of the rollers. The body part of the cylindrical fitting part 12, which is behind the tip part (the side of the flange part 13), has an outer diameter, which is a little larger than the inner diameter of the cylinder. Therefore, as shown in FIG. 2(b), the insertion of the body part in the cylinder becomes tight, after the tip part is inserted in the cylinder. However, due to the flexibility of plastics, the cylindrical fitting part 12 can be inserted in the cylinder and fitted with the cylindrical inner periphery, by pressing it into the cylinder by force. The fitting of the shaft member 10 is tight, and thus, it does not come off, because the body part of the cylindrical fitting part 12 strongly presses the cylindrical inner surface of the roller.

In the state that the fitting of the shaft member 10 is completed, as shown in FIG. 2(c), the flange part 13 comes into contact with the end surface of the roller and covers it. Thus, the flange part 13 lies between the roller and the frame part, in the situation in which the roller is supported by the shafts. Therefore, in the case where the rollers and the frame part are made of stainless steel, the generating of the uncomfortable sound of metal collision can be prevented, because the flange part functions as a buffer. In the above-mentioned constitution in which the shaft members 10, as separate members, are fitted to both sides of the roller, identical shafts can be used for rollers of different lengths, as far as the inner diameters of the rollers are identical. Therefore, it is not necessary to install shaft members of different lengths, even if the lengths of the rollers are not identical. This makes designing and manufacturing easy.

In the present embodiment, the lengths of the rollers (5, 6, 7, 8, 9) in the direction of their rotary central axes are not identical. The length of the 3^{rd} roller 7, which is located in the middle, is the largest, the lengths of the 2^{nd} and 4^{th} rollers (6, 8), which are on either side of the 3^{rd} roller 7, are the second largest, and the length of the 1^{st} and 5^{th} rollers (5, 9), which are located at either end, are the shortest. In this way, the central area of the head part occupies a large area in its surface area.

However, in the case where the surface area of the head part is too large, the contact with the face is not appropriate, and this affects a good performance. To avoid this, the length and the outer diameter of each roller should be properly set. For example, when the outer diameters of all the rollers are about 7 mm, each roller easily comes into contact with the fine unevenness of a face. In this case, by setting the lengths of the rollers, in the direction of the rotary central axis, 17 mm for the 3^{rd} roller 7, which is the longest, 16 mm for the 2^{nd} and 4^{th} rollers (6, 8) and 15 mm for the 1^{st} and 5^{th} rollers (5, 9), which are the shortest, the surface area of the head part 3 corresponds to the appropriate skin contact area. Here, to prevent each roller from colliding with the adjacent roller during rotation, a little space should be made between the rollers.

In the present embodiment, as shown in FIG. 1(b), the side view, the end parts (4a, 4b) of both right and left sides of the frame part 4 curve, so that they protrude in the upper direction. Therefore, the 1^{st} to 5^{th} rollers (5, 6, 7, 8, 9) are supported by shafts along these curves, and the curved line Z1, assumed by connecting the top of each roller, forms an approximately arc shape, which protrudes in the upper direction of the frame part. In this way, the surface of the head part 3 becomes substantially a curved surface, and this curved surface fits well with the rough unevenness of a face, and thus users do not have the feeling that the head part 3 detaches from their face during the massage. Therefore, all the rollers always rotate simultaneously and press the face, and thus sufficient massaging effect and a good feeling of use are obtained. When the above-mentioned curved line Z1 has the curvature radius of 100 mm, the above-mentioned good contact with the face is achieved, and is thus most preferable.

In the present embodiment, to further improve the massaging effect, magnets 16 and an infrared rays radiation ceramic part 17 are installed. For this purpose, a back lid 15 is installed in the frame part 4, in such a way that the rear surface of the head part 3 is covered by the back lid 15, and, between the inner side of the back lid 15 and the 1^{st} to 5^{th} rollers (5, 6, 7, 8, 9), a storing space, in which the magnets 16 and the infrared rays radiation ceramic part 17 can be installed, is formed.

When a moving operation of the massage roller 1 of the present embodiment, which has the aforementioned constitution, is conducted, by gripping the handle part 2 and pressing the surface side of the head part 3 to a face, each roller (5, 6, 7, 8, 9) rotates in its rotary direction. The 2^{nd} and the 4^{th} rollers (6, 8), which are on either side of the 3^{rd} roller, and arranged like the Japanese character [symbol] , rotate in mutually different directions. Thus, the skin parts, with which the 2^{nd} and 4^{th} rollers (6, 8) come in contact, are pulled in different directions respectively, and the skin area between the 2^{nd} and 4^{th} rollers (6, 8) is massaged with the 3^{rd} roller 7 in an extended state. Therefore, by a simple operation of moving the head part 3 back and forth, while pressing it to one's face, an effect of wrinkle extending, in addition to the improvement of the blood circulation and the canceling of swelling, can be achieved at the same time.

### Embodiment 2

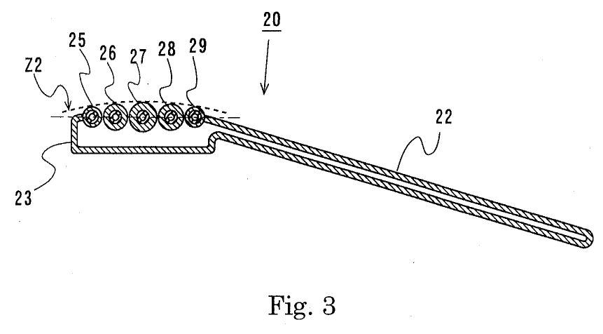

In the above-mentioned embodiment, to make the surface of the head part an appropriate curved surface, the end parts of both right and left sides of the frame part are curved, and the 1^{st} to 5^{th} rollers (5, 6, 7, 8, 9) are supported by shafts along these curves. FIG. 3, a side sectional view, shows, as the second embodiment of the present device, a face massage roller 20, having another constitution in which the surface of the head part is substantially a curved surface.

In the present embodiment, the surface of the head part 23 becomes substantially a curved surface, by setting the outer diameters of the 1^{st} to 5^{th} rollers (25, 26, 27, 28, 29) with appropriate different values.

That is, the outer diameter of the 3^{rd} roller 27 is the largest, the outer diameters of the 2^{nd} and 4^{th} rollers (26, 28), which are located on either side of the 3^{rd} roller 27, are the second largest, and the outer diameters of the 1^{st} and 5^{th} rollers (25, 29), which are located on either end side, are the smallest. Thus, when all the rollers are arranged in such a way that their rotary central axes are on the same straight line, the curved line Z2, assumed by connecting the top of all the rollers, forms an arc shape, which protrudes in the upper direction of the frame part.

Therefore, by properly setting the differences in the heights from the central axes to the tops of the rollers, that is, the differences of the outer diameters of the rollers, the above-mentioned curved line Z2 can be an arc having the curvature radius of 100 mm, which corresponds to a curved surface suitable for contact with the face's surface.

In this case, unlike embodiment 1, it is not necessary to curve the end parts of both right and left sides of the frame part. Moreover, there is no difference in the positions of the bearings in the direction of height, because the above-mentioned end parts are not curved. Therefore, insertion of the shaft parts of the 2^{nd} and 4^{th} rollers, which are arranged with certain angels, into concave bearings is easy. This makes the designing and manufacturing of the frame part easy.

What is claimed is:

1. A face massage roller, having a long rod shaped handle part and a head part for massaging, which is installed at the tip of said handle part, comprising:
a) a frame part and 1^{st}, 2^{nd}, 3^{rd}, 4^{th} and 5^{th} rollers at said head part, said frame part being formed with said handle part in one piece, and said rollers being cylindrical, being supported by shafts in a rotatable state in said frame part, and having a surface subjected to anti skid processing,
b) wherein said 1^{st} to 5^{th} rollers are arranged side by side in a direction of a longitudinal axis of said handle part, in turn from an outside of said handle part, and the rotary central axes of said 1^{st}, 3^{rd} and 5^{th} rollers, among said five rollers, are mutually parallel and fall at right angles with the direction of the longitudinal axis of said handle part, and
c) wherein the rotary central axes of said 2^{nd} and 4^{th} rollers form a predetermined angle of inclination with the direction of the rotary central axis of said 3^{rd} roller, so that the 2^{nd} and 4^{th} rollers, which are on either side of the 3^{rd} roller, assume an approximately Japanese character [symbol] form.

2. The face massage roller according to claim 1, wherein in relation to the direction of the rotary central axis of said 3^{rd} roller, the angles of inclination of the rotary central axes of said 2^{nd} and 4^{th} rollers are within a range of 0.2° and 2°, and are independent from each other.

3. The face massage roller according to claim 1, wherein the lengths of said 2^{nd} and 4^{th} rollers in the direction of their rotary central axes are larger than the length of said 1^{st} and 5^{th} rollers in the direction of their rotary central axes, and the length of said 3^{rd} roller in the direction of its rotary central axis is larger than the length of said 2^{nd} and 4^{th} rollers in the direction of their rotary central axes.

4. The face massage roller according to claim 1, wherein said 1^{st} and 5^{th} rollers are arranged in a way that a curved line, assumed by connecting a top of each roller on a surface side of the head part, along the direction of the longitudinal axis of said handle part, forms an approximately arc shape, which protrudes in an upper direction of said frame part.

5. The face massage roller according to claim 1, wherein the outer diameters of said 2^{nd} and 4^{th} rollers are smaller than an outer diameter of said 3^{rd} roller, and the outer diameters of said 1^{st} and 5^{th} rollers are smaller than the outer diameters of said 2^{nd} and 4^{th} rollers.

6. The face massage roller according to claim 1, wherein each of said 1^{st} to 5^{th} rollers is held by bearing parts through a pair of plastic shaft members,
said bearing parts being formed in said frame part, and
said plastic shaft members being fitted within cylindrical inner peripheries at both ends of the rollers, in a way that said plastic shaft members cover the end surfaces of the corresponding roller.

7. The face massage roller according to claim 1, wherein
a) said face massage roller has a back lid, which is installed in said frame part, so that a rear surface of said head part is covered by said back lid, and
b) a magnet and an infrared ray radiation ceramic part are installed between an inner side of said back lid and said 1^{st} to 5^{th} rollers.
